(19) United States
(12) Patent Application Publication
(10) Pub. No.: US 2003/0012250 A1
(43) Pub. Date: Jan. 16, 2003

(54) Tunable filter for laser wavelength selection

(76) Inventor: Masataka Shirasaki, Winchester, MA (US)

Correspondence Address: Corlux Corporation, 47361 Bayside Parkway, Fremont, CA, 94538, US

(21) Appl. No.: 09/891,111

(22) Filed: Jun. 25, 2001

(51) Int. Cl. H01S 3/10

(52) U.S. Cl. 372/98

(57) ABSTRACT

The invention relates to apparatus and methods for tuning the wavelength of a laser. According to one embodiment, the wavelength tunable filter includes a first wavelength selective element having a first thickness, a first refractive index and a first spectral response having a plurality of transmission peaks having an associated first period. The filter also includes a second wavelength selective element having a second thickness, a second refractive index and a second spectral response having a plurality of transmission peaks having an associated second period. Additionally, the filter includes a control module to vary at least one of the first thickness, the second thickness, the first refractive index, and the second refractive index such that one of the plurality of transmission peaks of the first spectral response substantially overlaps one of the plurality of transmission peaks of the second spectral response.

### FIELD OF THE INVENTION

This invention relates generally to optical devices, and more specifically to wavelength tunable filters suitable for use in a laser cavity.

### BACKGROUND OF THE INVENTION

The demand for increased communication data rates necessitates a constant need for improved technologies to support that demand. One such emerging technology area is in fiber-optic communications, in which data is transmitted as light energy over optical fibers. To increase data rates, more than one data channel can exist on a single fiber link. For example, in wavelength division multiplexing (“WDM”), different channels are differentiated by wavelength. This differentiation requires special optical components to combine and separate the different channels for transmission, switching and receiving data. In WDM systems, a tunable filter for laser wavelength selection is needed that can select an intended wavelength from many different wavelengths that can be supported in a laser. Specifically, a filter having a narrow bandwidth, a wide tunable range, and a low loss is required.

An analysis of the energy levels of laser transitions indicates that a laser can generate light over a range of wavelengths according to its gain spectrum. The energy output over the gain curve is not continuous but occurs at discrete, closely spaced frequencies. The frequencies are based upon the number of discrete longitudinal modes that are supported by the laser cavity. Laser oscillation occurs only at wavelengths for which the gain exceeds the loss in the optical path.

Various techniques have been used to limit the oscillation of a laser to one of the competing longitudinal modes. One of the more common methods includes the use of a frequency selective etalon. An etalon typically consists of an optical plate with parallel surfaces. Internal reflections give rise to interference effects which cause the etalon to behave as a frequency selective transmission filter, passing with minimum loss a narrow band of frequencies about a series of transmission peaks and rejecting other frequencies. A transmission peak of the etalon, in practice, is set to coincide with a specific longitudinal mode, resulting in single frequency operation of the laser. The transmission peak of the etalon can be tuned in frequency, for example, by adjusting the angle of the etalon in the cavity. Tuning by adjusting the angle is limited because it tends to increase power losses. In practice, the etalon is tuned such that its transmission peak is in alignment with a particular longitudinal mode and then maintained at a fixed temperature during operation.

The particular modes oscillating in a laser are directly related to the length of the resonator. Therefore, as the length of the resonator drifts, the frequency of any given mode and, thus, the frequency of the output of the laser will also drift. As the frequency of the selected mode drifts, it moves out of alignment with the peak of the transmission curve of the etalon and the output power of the laser decreases. If the length of the laser cavity continues to change, eventually an “adjacent” longitudinal mode is transmitted by the etalon and the optical output of the laser abruptly shifts to the frequency of the adjacent mode. One way to minimize “mode hopping” is to create a highly stabilized cavity in which length changes are minimized. In practice, it is difficult to sufficiently minimize cavity length changes. In another approach, the length of the cavity is actively stabilized. In this approach, the position of a cavity mirror is varied to maintain a selected cavity length, even as temperature variations occur.

Current conventional tunable filters include, for example, a diffraction grating having an angular orientation with respect to the cavity axis that is controlled by a motor and an etalon having an effective path length that is changed by rotating the etalon. Additionally, a piezoelectric cell coupled to one or both of the resonator mirrors can control the effective path length of the laser cavity. These have significant disadvantages. For example, the diffraction grating and the etalon are bulky modules since they are mechanically controlled. In addition, the range of tunability of these devices is limited.

What is needed is a tunable filter for laser wavelength selection which does not suffer from the drawbacks of current tunable filter designs.

### SUMMARY OF THE INVENTION

In one embodiment, the invention relates to a wavelength tunable filter. The filter includes a first wavelength selective element having a first thickness, a first refractive index, and a first spectral response having a plurality of transmission peaks having a first period. The filter also includes a second wavelength selective element having a second thickness, a second refractive index, and a second spectral response having a plurality of transmission peaks having a second period. The filter further includes a control module for varying at least one of the first thickness, the second thickness, the first refractive index, and the second refractive index. In response to the operation of the control module, one of the transmission peaks of the first spectral response substantially overlaps one of the transmission peaks of the second spectral response.

In another embodiment, the first thickness and/or the first refractive index are temperature dependent and the control module varies a temperature of the first wavelength selective element. In still another embodiment, one of the first and second wavelength selective elements is insensitive to temperature. In yet another embodiment, at least one of the plurality of transmission peaks having the first period corresponds to a wavelength division multiplexer channel. In still another embodiment, each of the plurality of transmission peaks having the first period corresponds to a wavelength division multiplexer channel at a corresponding temperature. Additionally, the filter can be used in a laser cavity. The filter can further include a variable phase adjuster.

In one embodiment, at least one of the first and second wavelength selective elements is an etalon. The etalon can include a surface having an electrically conductive film. The temperature of the etalon is responsive to an electric current conducted through the electrically conductive film.

The invention also relates to a wavelength tunable laser. The laser includes first and second mirrors defining a laser cavity. The laser also includes a gain element located within the laser cavity. The laser further includes a wavelength tunable filter located within the laser cavity. The filter includes a first etalon having a first thickness, a first refractive index, and a first spectral response having a plurality of transmission peaks having a first period. The filter also includes a second etalon having a second thickness, a second refractive index, and a second spectral response having a plurality of transmission peaks having a second period. The filter further includes a control module for varying at least one of the first thickness, the second thickness, the first refractive index, and the second refractive index. In response to the operation of the control module, one of the transmission peaks of the first spectral response substantially overlaps one of the transmission peaks of the second spectral response.

In another embodiment, the wavelength tunable laser includes a laser cavity. The laser cavity includes a gain element. The laser cavity also includes a wavelength tunable filter. The wavelength tunable filter includes a first interferometer having a first optical path difference and a first spectral response having a plurality of transmission peaks having a first period. The laser cavity also includes a second interferometer having a second optical path difference and a second spectral response having a plurality of transmission having a second period. The wavelength tunable filter also includes a control module for changing at least one of the first optical path difference and the second optical path difference. In response to the operation of the control module, one of the transmission peaks of the first spectral response substantially overlaps one of the transmission peaks of the second spectral response.

In one embodiment, the control module is adapted to vary the temperature of the first and/or second interferometer. In still another embodiment, one of the first or second interferometers is insensitive to temperature. In another embodiment, at least one of the plurality of transmission peaks having the first period corresponds to a wavelength division multiplexer channel. In yet another embodiment, each of the plurality of transmission peaks having the first period corresponds to a wavelength division multiplexer channel at a corresponding temperature.

The invention is also embodied in a method of tuning a laser wavelength. The method includes providing a first wavelength selective element having a first thickness, a first refractive index and a first spectral response having a plurality of transmission peaks having a first period. The method also includes providing a second wavelength selective element having a second thickness, a second refractive index and a second spectral response having a plurality of transmission peaks having a second period. The method further includes modifying at least one of the first thickness, the second thickness, the first refractive index and the second refractive index to generate an overlap of one of the transmission peaks of the first spectral response and one of the transmission peaks of the second spectral response. In one embodiment, the method includes adjusting a temperature of at least one of the first and second wavelength selective elements.

In another embodiment, the invention relates to a wavelength tunable filter including first selection means for selecting a first plurality of wavelengths for transmission and second selection means for selecting a second plurality of wavelengths for transmission. The laser further includes means for shifting at least one of the first plurality of wavelengths and the second plurality of wavelengths such that one of the first plurality of wavelengths is substantially equal to one of the second plurality of wavelengths.

In one embodiment, the first or second period of transmission peaks is equal to the WDM channel spacing. In another embodiment, the first or second plurality of wavelengths for transmission is identical to the WDM channel wavelengths.

### BRIEF DESCRIPTION OF THE DRAWINGS

The above and further advantages of the invention may be better understood by referring to the following description taken in conjunction with the accompanying drawings, in which:

FIG. 1A & FIG. 1B is a diagram of a Fabry-Perot interferometer and its corresponding transmission spectrum, respectively;

FIG. 2 is a block diagram of an illustrative wavelength tunable filter in a laser cavity according to the invention;

FIG. 3 is a graphical representation of transmission as a function of frequency for the wavelength tunable filter of FIG. 2;

FIG. 4 is a block diagram of an embodiment of a temperature controllable etalon according to the invention;

FIG. 5 is a block diagram of an embodiment of a laser resonator including the wavelength tunable filter of the invention;

FIG. 6 is a block diagram of an embodiment of a variable-length laser resonator including the wavelength tunable filter of the invention;

FIG. 7 is a block diagram of an embodiment of a laser resonator including a wavelength tunable filter according to another embodiment of the invention;

FIG. 8 is a graph of the output optical phase versus the wavelength of the optical energy for the reflection-type Fabry-Perot interferometer of FIG. 7;

FIG. 9A & FIG. 9B illustrate two etalons located in a substantially uniform temperature zone, and a graphical representation of the corresponding transmitted frequencies as a function of temperature, respectively;

FIG. 10A & FIG. 10B illustrate a combination of a temperature insensitive etalon and a temperature dependent etalon, and a graphical representation of the corresponding transmitted frequencies as a function of temperature, respectively;

FIG. 11 is a block diagram of a ring interferometer;

FIG. 12 is a block diagram of an embodiment of two ring interferometers in a parallel configuration according to the invention;

FIG. 13A & FIG. 13B are block diagrams of a Mach-Zehnder interferometer and a Michelson interferometer, respectively; and

FIG. 14 is a flowchart of an embodiment of the method according to the invention.

### DETAILED DESCRIPTION

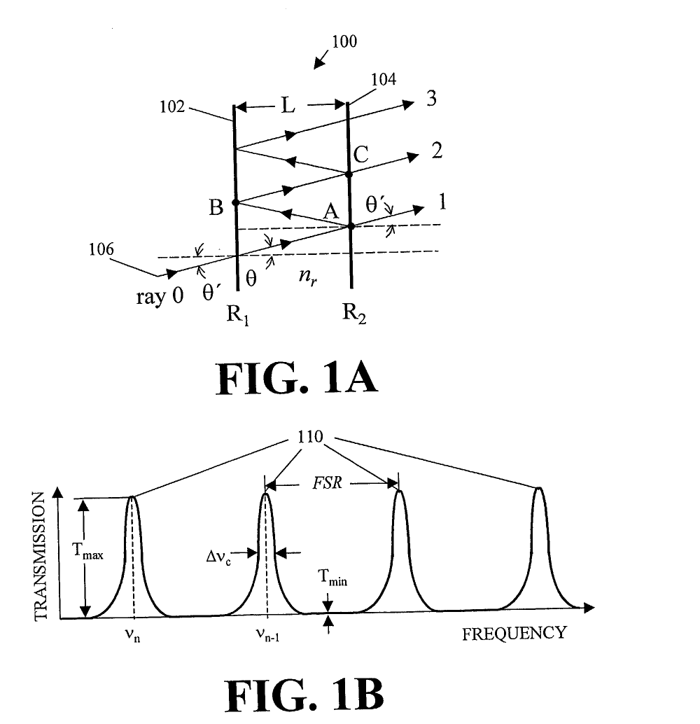

FIG. 1A is a diagram showing multiple-beam interference of a Fabry-Perot (“FP”) interferometer 100. The illustrative FP interferometer 100 consists of two plane parallel reflective surfaces 102, 104 having optical power reflectivities R₁ and R₂. The surfaces 102, 104 are separated by a distance L across a medium of refractive index nᵣ. (In an alternative embodiment (not shown) the interferometer 100 consists of spherical reflective surfaces.) A plane wave (represented by ray 0 106) of wavelength λ is incident on the interferometer 100 at an angle θ′ with the normal to each reflective surface 102, 104. The output beam exiting the interferometer 100 consists of a superposition of the plane wave resulting from a single pass through the interferometer (ray 1) and the beams arising from multiple reflections within the interferometer (e.g., ray 2 and ray 3).

FIG. 1B illustrates the transmission of the FP interferometer 100 as a function of frequency. The transmission consists of a series of evenly spaced transmission maxima 110. The frequency difference between consecutive maxima 110 is called the free spectral range (“FSR”) of the interferometer and is given by:

$$FSR = \frac{c}{2 {L}^{′}} \qquad ( 1 )$$

where c is the speed of light and L′ is the effective optical length (i.e., the physical length L multiplied by the index of refraction nᵣ of the medium) of the interferometer cavity. The finesse F of the interferometer 100 indicates the width Δν_{c} of each transmission peak relative to the FSR and is given by:

$$F = \frac{FSR}{Δ {v}_{c}} \qquad ( 2 )$$

Generally the finesse F of the etalon increases as its surface reflectances increase.

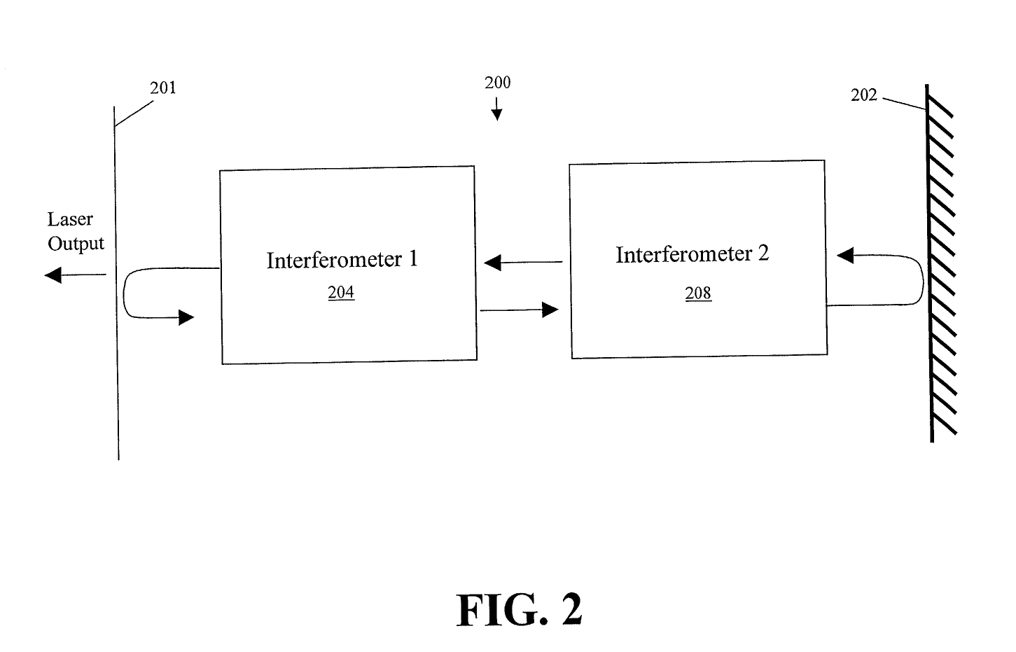

FIG. 2 is a block diagram of an embodiment of a laser cavity including the wavelength tunable filter 200 of the present invention in which a first interferometer 204 is optically coupled to a second interferometer 208. The laser cavity also includes a laser output mirror 201 and a “perfect” mirror 202 (i.e., a mirror having nearly 100% reflectivity). In one embodiment, the first and second interferometers 204, 208 are Fabry-Perot (“FP”) etalons. The first and second interferometers 204 and 208 are also referred to herein as “wavelength selective elements.” In the preferred embodiment, the free spectral ranges of the first and second interferometers 204, 208 are different.

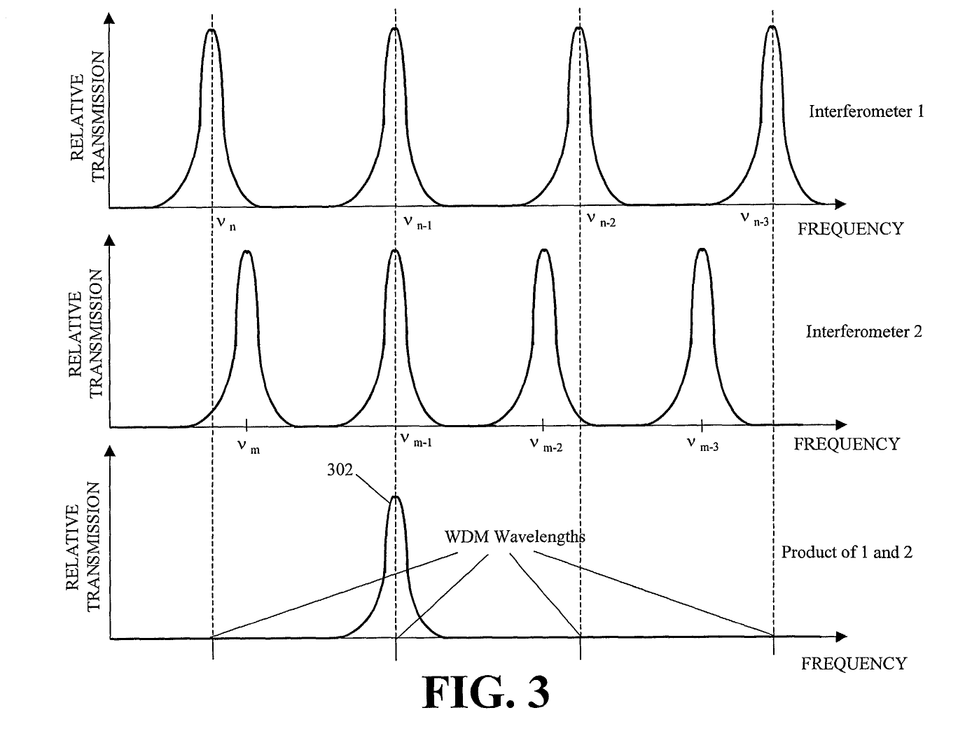

FIG. 3 graphically depicts the spectral response of the first and second interferometers 204, 208 and the product 302 of the spectral responses of the two cascaded interferometers of FIG. 2. The spectral response is the transmission as a function of the frequency of the incident light. Thus only one passband is present for the range of frequencies shown. The degree of coincidence between the two overlapping transmission peaks determines the maximum transmission of the passband.

Due to the periodic nature of the spectral responses, the transmission peaks generally overlap at other frequencies. Ideally, these “adjacent” overlapped peaks occur outside the gain frequency range of the laser. In one example, the spectral response of the second interferometer 208 has an FSR which is 90% of the FSR of the spectral response of the first interferometer 204. The next higher frequency peak overlap occurs at a frequency that is greater than the “current” frequency by ten times the FSR of the second interferometer 208 or, equivalently, at a frequency that is greater than the current frequency by nine times the FSR of the first interferometer 204. For etalons having a narrow Δν_{c}, the difference in FSRs can be as small as one percent. Increasing the reflectivity of the surfaces of the first and second interferometers 204, 208 (i.e., increasing the finesse F) narrows the transmission peaks. Consequently, the occurrence of partially overlapped peaks is reduced. However, if the finesse F of each interferometer 204, 208 is too high, it can be difficult to achieve the desired overlap of the transmission peaks.

One method to change the spectral response of an etalon is to vary the effective optical path length through the etalon. This can be accomplished, for example, by changing the temperature of the etalon so that the transmission peaks of the spectral response shift in an accordion-like fashion (i.e., the transmission peaks shift with respect to frequency and with respect to each other). Small changes in the temperature of the etalon can be generated to shift the spectral response of the etalon through a predetermined spectral range. By adjusting the temperature of the second interferometer 208 while keeping the temperature of the first interferometer 204 constant, a transmission peak in the range of the gain frequency can be made to substantially overlap at one frequency. As the temperature of the second interferometer 208 is further adjusted, another transmission peak in the gain frequency range (corresponding to another frequency) can be overlapped. A wide range of frequency tuning can be achieved with a relatively small change in temperature of the interferometer. In one embodiment, the temperatures of both the first and second interferometers are adjusted. In one embodiment, the temperature of the first or second interferometer 204, 208 can be adjusted from about 20° C. to about 75° C.

In the preferred embodiment, the first interferometer 204 is designed such that its spectral response has transmission peaks which correspond to the desired WDM channel wavelengths. In this case, the spectral response of the first interferometer 204 is unchanged, while adjusting the temperature of the second interferometer 208 shifts the spectral response of the second interferometer 208 to enable the selection of a different WDM channel. The first and second interferometers 204, 208 can be calibrated to finely tune the corresponding spectral responses. In another embodiment, the index of refraction of at least one of the etalon interferometers 204, 208 is changed (e.g., by introducing a gas into the etalon interferometer) to shift its respective spectral response.

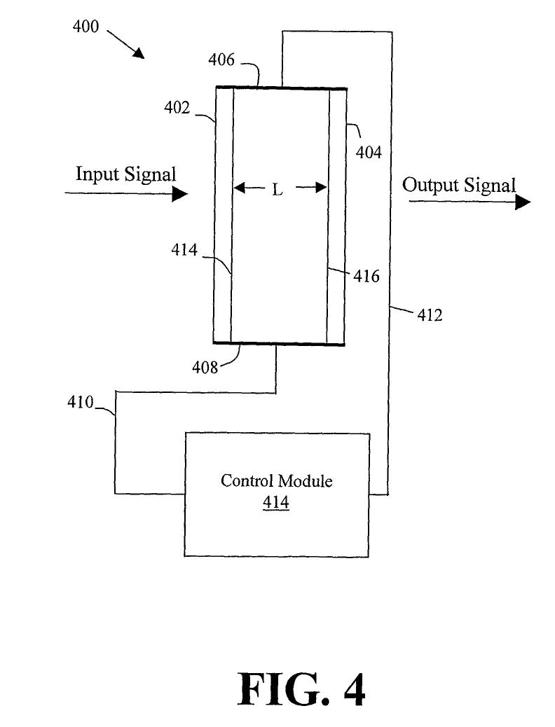

FIG. 4 is an illustrative embodiment of a temperature-controlled etalon 400 according to the invention. The etalon 400 is formed from an optical glass. The endfaces 414, 416 are flat and substantially parallel to each other. High reflectivity coatings 402 and 404 are applied to the endfaces 414 and 416, respectively. The coatings 402 and 404 are made from an electrically conductive material designed to be partially transmissive. The coatings 402 and 404 can be applied using various techniques such as vapor deposition, sputtering, and chemical deposition. The coatings 402 and 404 function as heater elements which increase the temperature of the etalon 400 when electrical current is conducted through them. Conductive bridges 406 and 408 electrically connect the coatings 402 and 404 to form a parallel circuit. In another embodiment (not shown), the coatings 402 and 404 are serially coupled. Electrically conductive paths 410 and 412 couple conductive bridges 406 and 408 to an electrical power source in control module 414. The control module 414 varies the current through the coatings 402 and 404 to achieve a desired temperature of the etalon 400. In another embodiment, a semi-transparent electrically conductive sheet (not shown) is attached to each endface 414 and 416 of the etalon 400. In an alternative embodiment, the endfaces 414 and 416 of the etalon 400 are coated with both a highly reflective coating and a conductive coating. In an alternative implementation, the etalon 400 is heated by an oven (not shown). Skilled artisans will appreciate that various techniques can be used to vary the temperature of an etalon without departing from the scope of the invention.

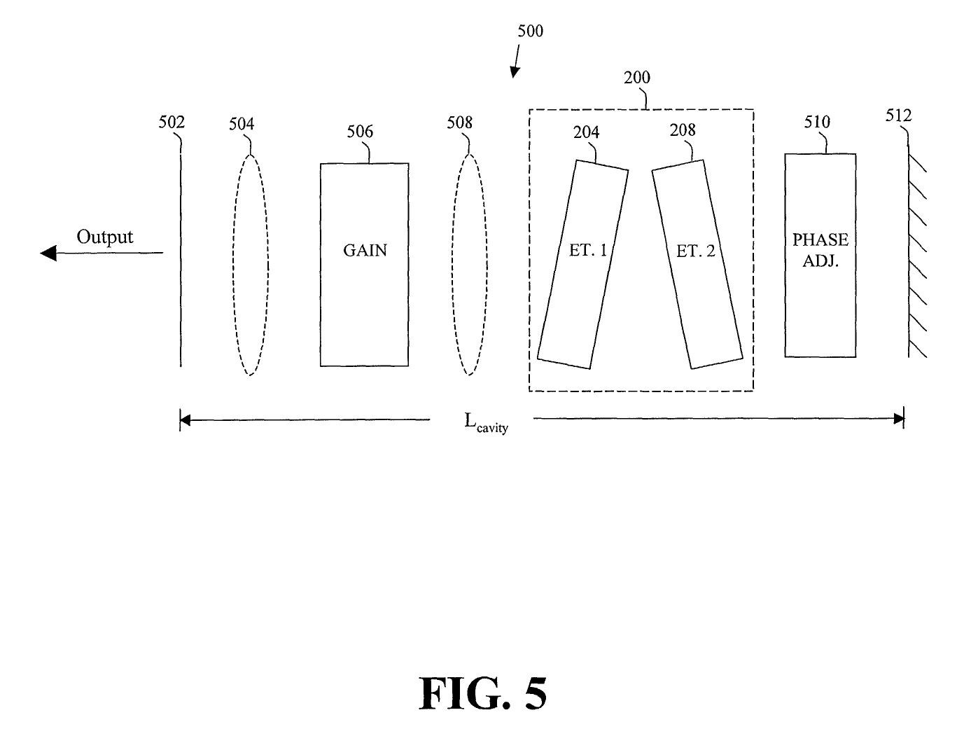

FIG. 5 is a block diagram of a laser resonator 500 including the wavelength tunable filter 200 of the present invention. The laser resonator 500 also includes a high reflectivity output coupler 502 and a “perfect” mirror (e.g., a mirror with a reflectivity greater than 99%) 512 defining the laser cavity. The resonator 500 also includes a gain element 506, a phase adjuster 510, and coupling lenses 504 and 508. The coupling lenses 504 and 508 are used to image the optical energy in the gain medium (e.g., a semiconductor waveguide medium).

The wavelength tunable filter 200 includes a first etalon 204 and a second etalon 208. The etalons 204 and 208 are tilted with respect to each other and with respect to other elements in the resonator 500 to avoid creating undesired sub-cavities within the main laser cavity.

In one embodiment, the laser resonator 500 has a cavity length (L_{cavity}) of about 2 cm. This length is about twenty times greater than the optical thickness of each etalon 204 and 208; therefore, there are approximately twenty resonator modes in a period of transmission peaks for either etalon, 204 or 208. Depending on the finesse F of each etalon 204 and 208, there can be two or three resonator modes (frequencies) within the transmission peak of each etalon 204 and 208. If two resonator modes of equal magnitude are located within a transmission peak, both modes can experience laser oscillation. In order to maintain single mode operation, the resonator modes can be shifted within the transmission peak using the phase adjuster 510 such that only the desired resonator mode oscillates. The phase adjuster 510 shifts the frequency of the oscillating modes by varying the effective cavity length of the laser cavity 500. Adjusting the temperature of the phase adjuster 510 changes the optical path length (i.e., the product of path length and the index of refraction) of the phase adjuster 510 which also varies the effective cavity length of the laser cavity 500.

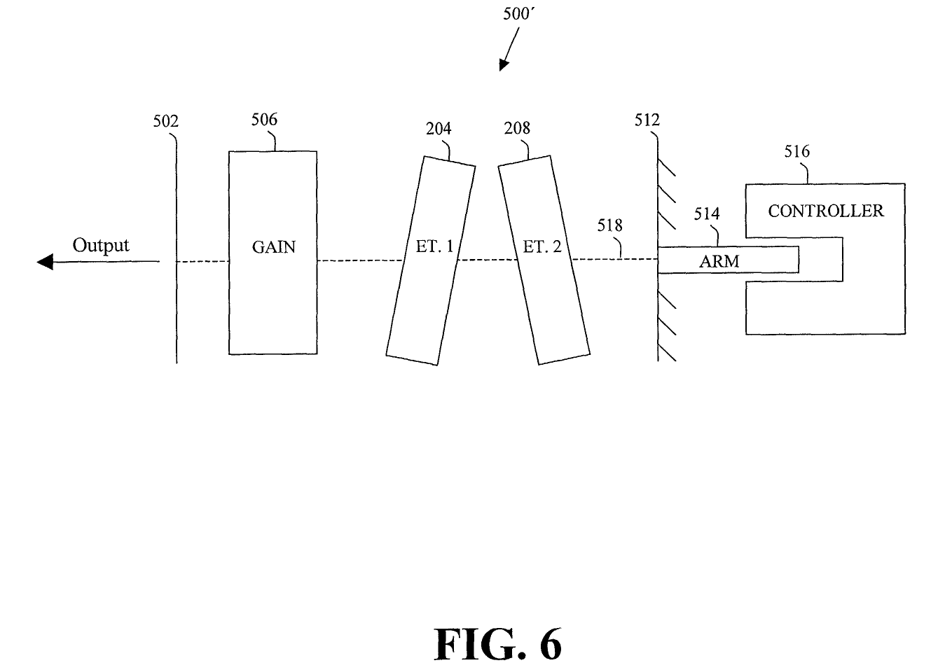

FIG. 6 illustrates a variable length laser resonator 500′ according to an embodiment of the invention. In this embodiment, the phase adjuster 510 is not required. Instead, a movable “perfect” mirror 512 performs the function of the phase adjuster 510. The mirror 512 is mounted to an actuator arm 514 coupled to a controller 516. The controller 516 varies the position of the “perfect” mirror 512 along the resonator axis 518. In one embodiment, the controller 516 is a piezoelectric controller. Alternatively, the mirror 512 can be adjusted by using thermal expansion properties of the arm 514. Skilled artisans will appreciate that other methods of changing the resonator length can be used without departing from the scope of the invention.

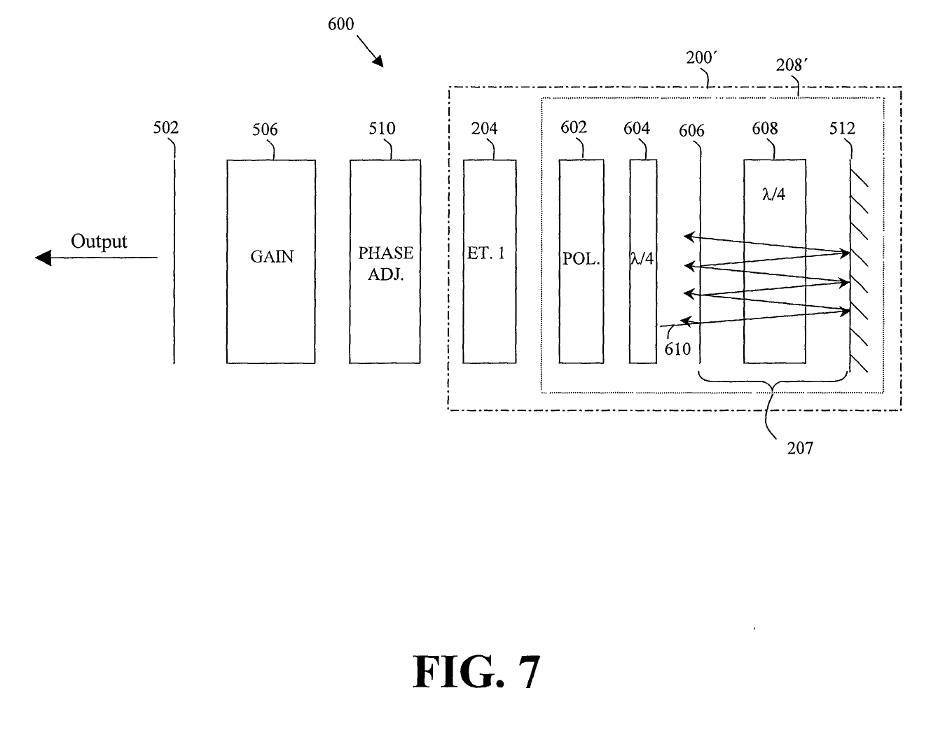

FIG. 7 is a block diagram of another laser resonator 600 including a wavelength tunable filter 200′ according to the present invention. The wavelength tunable filter 200′ includes a first etalon 204 and a reflection-type Fabry-Perot interferometer 208′. The interferometer 208′ includes a linear polarizer 602, a quarter-wave plate 604, a high reflectivity mirror 606, a quarter-wave plate 608, and a “perfect” mirror 512 (e.g., a near 100% reflectivity mirror). The high reflectivity mirror 606 has a reflectivity between 94% and 98%.

The “perfect” mirror 512 and the high reflectivity mirror 606 define a cavity. All of the incident optical energy 610 at mirror 606 is eventually transmitted through the high reflectivity mirror 606 after multiple reflections in the cavity 207. This is due to the principal of conservation of energy (assuming no energy consumption in the cavity). Except at the resonant frequencies, the mirror 606 largely reflects the optical signal 610 entering the cavity 207 of the interferometer 208′. The optical phase near the resonant frequencies changes by 2π. The optical phase change occurs for orthogonal polarizations alternately, due to the quarter-wave plate 608. The axes of the quarter-wave plate 604 and the quarter-wave plate 608 are at 45 degrees with respect to the axis of the polarizer 602. Therefore, the polarization of the light returning to the polarizer 602 is rotated by 90 degrees and the light energy is absorbed by the polarizer 602 except at the resonant frequencies.

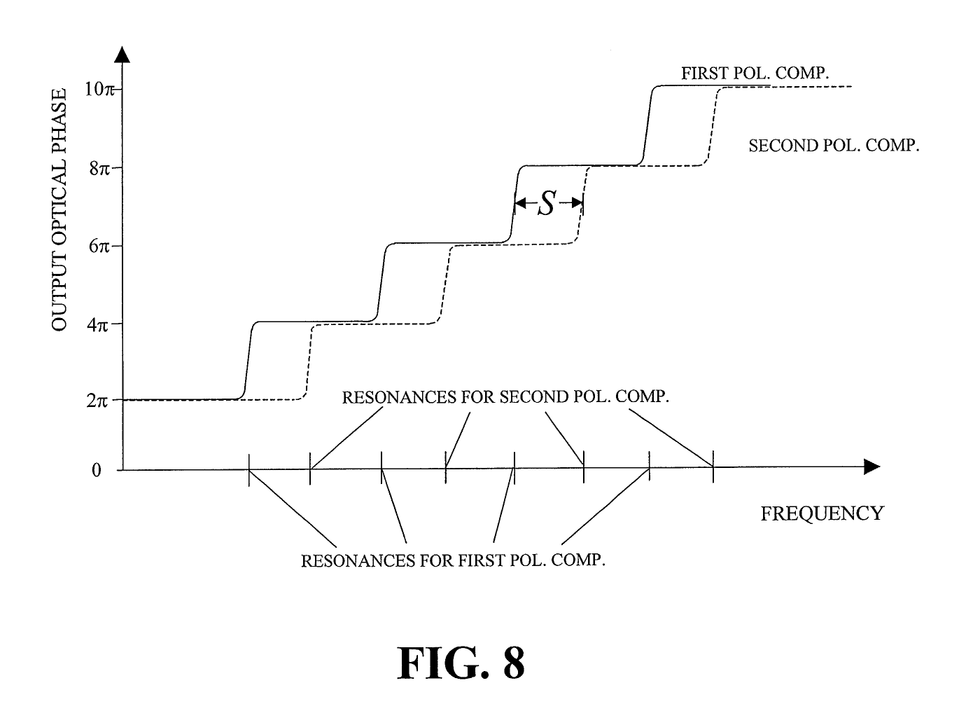

FIG. 8 is a graphical representation of the output optical phase of an optical signal in the interferometer 208′ versus the frequency of the optical signal. As the frequency of the optical signal increases, the output optical phase changes in a step-like fashion. Since the resonance frequency is related to the effective cavity length, the location of each step corresponds to a resonance frequency of the cavity 207 of the interferometer 208′. Therefore, the positions of the 2π steps of the optical phase in FIG. 8, which correspond to the resonance frequencies, are equally spaced, and the light returns to the gain medium 506 at the resonant frequencies only. The interferometer 208′ functions equivalently to the interferometer 208 with the mirror 202 of FIG. 2.

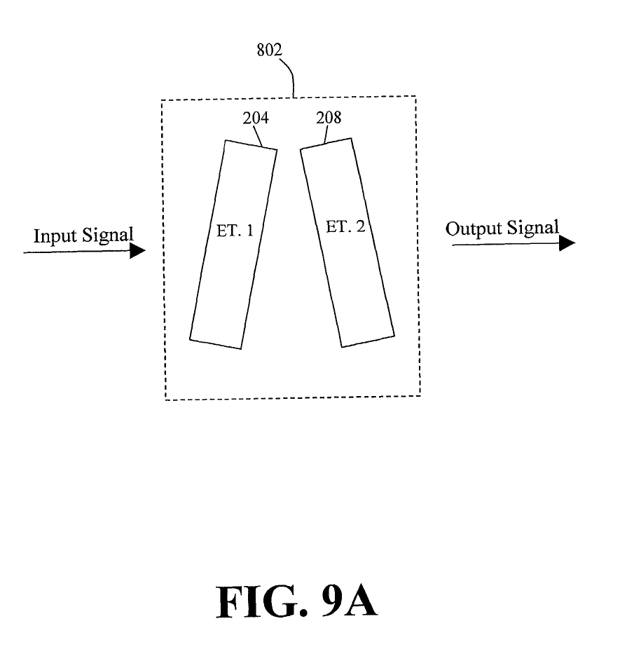

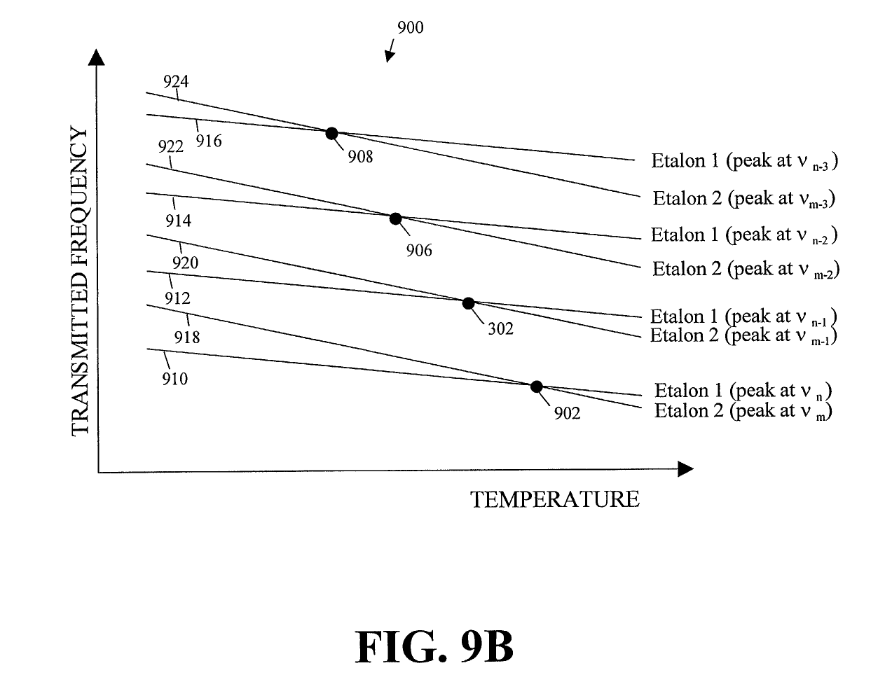

In one embodiment, the temperature of the first etalon 204 of FIG. 5 is constant, while the temperature of the second etalon 208 is varied. In another embodiment, the temperature of each etalon 204 and 208 is varied separately. In yet another embodiment, the temperature of both etalons 204 and 208 is varied simultaneously and by the same degree. FIG. 9A illustrates two etalons 204 and 208 located in a substantially uniform temperature zone 802. In one embodiment, the etalons 204 and 208 are fabricated from different materials having different coefficients of thermal expansion and/or different refractive index changes. As the temperature of the etalons 204 and 208 is changed, the spectral responses of the etalons 204 and 208 are also changed. Therefore, each etalon 204 and 208 has a different spectral response when they are both subjected to the same temperature. In one embodiment, the etalons 204 and 208 can be designed such that when each is subjected to the same temperature, a transmission peak from the spectral response of the first etalon 204 substantially overlaps a transmission peak from the spectral response of the second etalon 208.

FIG. 9B is a graphical illustration 900 of “transmitted frequency” as a function of temperature for the etalons 204 and 208 of FIG. 9A. Each line in the graph represents the center frequency of a given transmission peak in the spectral response as a function of temperature for one of the etalons 204 or 208. Referring to lines 910, 912, 914, and 916, the center frequency of each transmission peak of the first etalon 204 (only four shown for clarity) shifts to lower frequencies as the temperature of the first etalon 204 is increased. Similarly, the center frequency of each transmission peak (lines 918, 920, 922, and 924) of the second etalon 208 shift to lower frequencies as the temperature of the second etalon 208 is increased. The spectral transmission characteristics of the etalons 204 and 208 have a different sensitivity to temperature based, in part, on the differences in the thermal sensitivities of their indices of refraction. As shown by its lesser slopes, the first etalon 204 is less sensitive to an increase in temperature than the second etalon 208. As the temperature of the etalons 204 and 208 increases, the intersection points 902, 302, 906, and 908 between the etalons 204 and 208 correspond to the frequency of the desired overlapping transmission bands (e.g., transmission band 302 in FIG. 3).

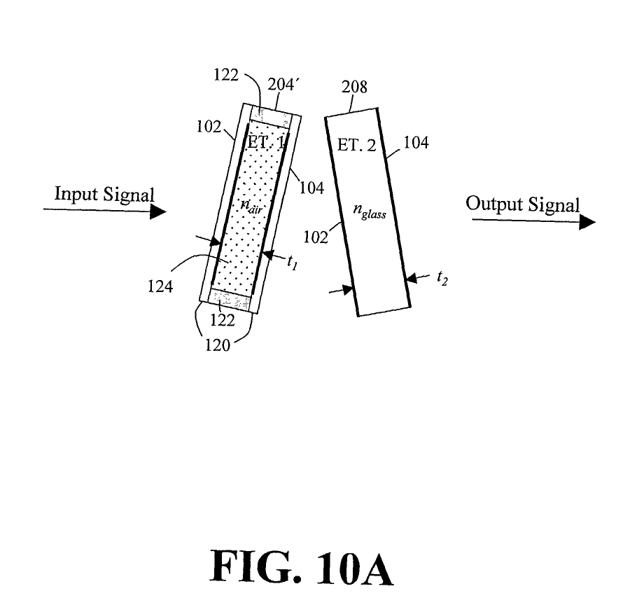

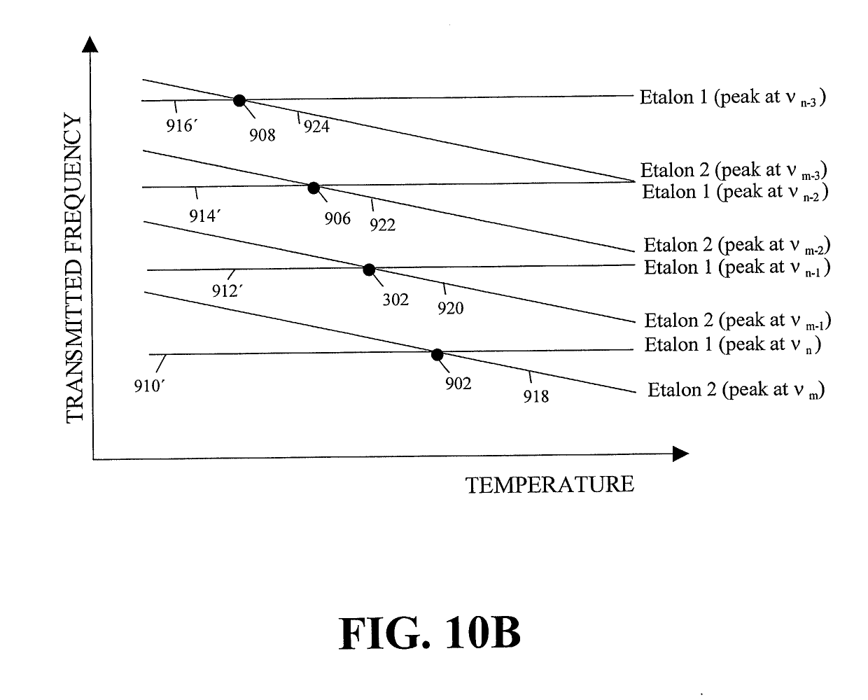

FIG. 10A illustrates a combination of a temperature insensitive etalon 204′ and a temperature dependent etalon 208 according to the invention. The temperature insensitive etalon 204′ includes two substantially parallel glass plates 120 which are coated with highly reflective coatings 102 and 104. The glass plates 120 define an air-filled cavity 124. The temperature insensitive etalon 204′ further includes spacers 122 disposed between the glass plates 120 to define the thickness of the cavity 124. In one embodiment, the spacers 122 are fabricated from a glass material having a slightly positive coefficient of thermal expansion (CTE). As the temperature of the spacers 122 increases, the physical lengths of the spacers 122 (and the thickness t₁ of the etalon 204′) also increase. The refractive index of the air nₐᵢᵣ inside the cavity 124 is approximately 1.00. As the temperature inside the cavity 124 increases, the refractive index of the air nₐᵢᵣ decreases. As the temperature of the etalon 204′ increases, the optical path length of the etalon 204′ remains substantially constant because the physical length of the cavity 124 increases while the refractive index nₐᵢᵣ of the air decreases. Thus, the etalon 204′ is substantially temperature insensitive.

The temperature dependent etalon 208 includes a glass plate of refractive index n_{glass} having substantially parallel sides coated with highly reflective coatings 102 and 104. As the temperature of the etalon 208 is varied, the refractive index n_{glass} and the thickness t₂ of the etalon 208 changes. Thus, the effective length of the etalon 208 changes with temperature. By controlling the temperature of the etalon 208, the combination of the etalons 204′ and 208 can be used to pass a desired wavelength band.

FIG. 10B is a graphical representation of transmitted frequency as a function of temperature for the two etalon configuration of FIG. 10A. Each line in the graph represents the center frequency of a given transmission peak in the spectral response as a function of temperature for one of the etalons 204′ or 208. Referring to lines 910′, 912′, 914′, and 916′, the center frequency of each transmission peak of the first etalon 204′ (only four shown for clarity) remains substantially constant in frequency as the temperature of the first etalon 204′ is increased. This is due to the relative temperature insensitivity of the first etalon 204′. Similarly, the center frequency of each transmission peak (lines 918, 920, 922, and 924) of the second etalon 208 shift to lower frequencies as the temperature of the second etalon 208 is increased. As the temperature of each of the etalons 204′ and 208 is increased, the intersection points 902, 302, 906, and 908 between the etalons 204′ and 208 correspond to the frequency of the desired overlapping transmission bands (e.g., transmission band 302 in FIG. 3).

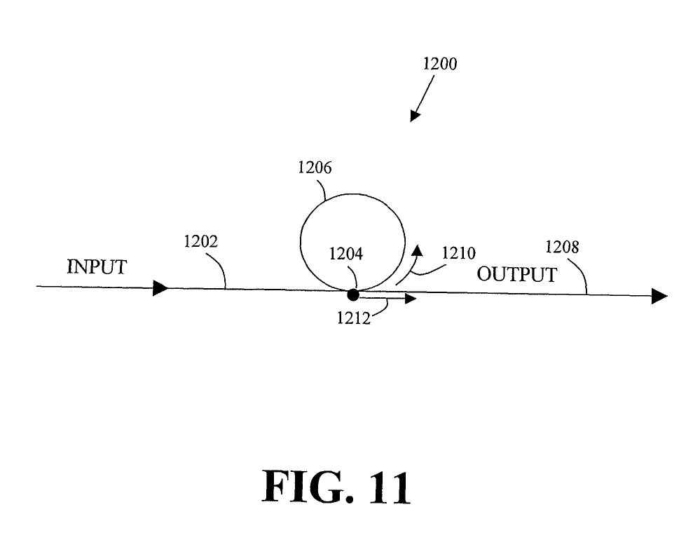

FIG. 11 illustrates a ring interferometer 1200 according to one embodiment of the invention. The ring interferometer 1200 behaves in a similar manner to the reflection-type Fabry-Perot interferometer 208′ of FIG. 7. An input signal propagates in the input waveguide 1202. After it encounters the coupler 1204, a portion 1212 of the input signal is transmitted to the output waveguide 1208, and a portion 1210 is coupled into the ring 1206. Each time a portion of the signal completes a trip around the ring 1206, a portion of the signal is coupled to the output waveguide 1208. As in the case of the interferometer 208′, the optical phase of the signal changes as a function of frequency. The optical phase change is related to the optical path length of the ring 1206. In one embodiment, the coupler 1204 is a 5% coupler. As the input signal encounters the coupler 1204, 95% of the input signal is transmitted to the waveguide 1208, while 5% is coupled into the ring 1206. The finesse F of the ring interferometer 1200 is related to the transmissivity of the coupler 1204 while the FSR is related to the optical path length of the ring 1206. The output phase of the ring interferometer 1200 is the same as shown in FIG. 8.

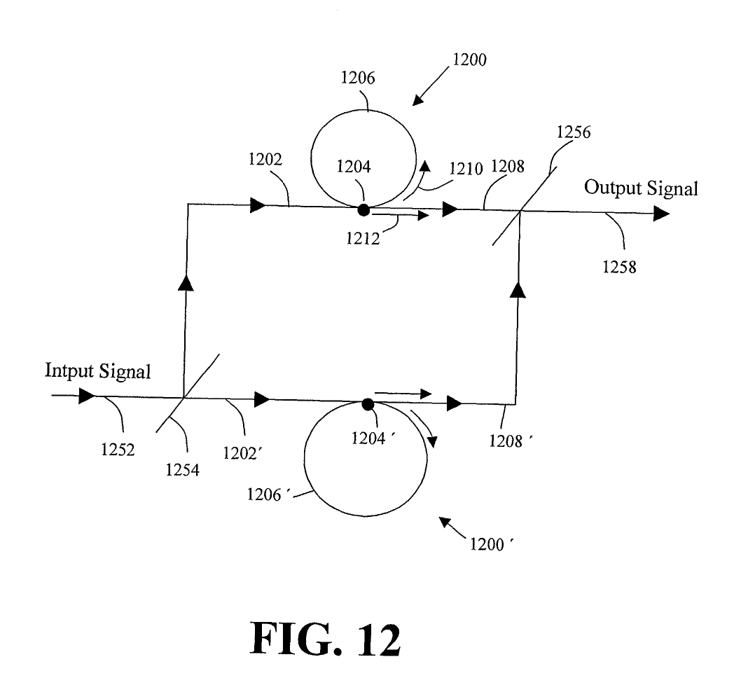

FIG. 12 illustrates two ring interferometers 1200 and 1200′ in a parallel configuration. This embodiment is analogous to the reflection-type Fabry-Perot interferometer 208′ in the configuration shown in FIG. 7. The ring interferometers 1200 and 1200′ include rings 1206 and 1206′, respectively, each having a different optical path length, the difference in the optical path lengths being approximately half the wavelength of an input signal. The input signal propagating in the input waveguide 1252 is split into two equal intensities along paths 1202 and 1202′ by the splitter 1254. Since the path length of each ring 1206 and 1206′ is different, the output phase versus wavelength characteristic for each ring interferometer 1200 and 1200′ is different (as shown in FIG. 8). After exiting couplers 1204 and 1204′, the signals propagate in the waveguides 1208 and 1208′, respectively. The mirror 1256 combines the signals into the output waveguide 1258. Hence, the parallel ring resonator configuration 1200 has a spectral response which is similar to the spectral response of the interferometer 208′ as described with reference to FIG. 7. Skilled artisans will appreciate that this configuration can be utilized for waveguide devices such as semiconductor laser devices.

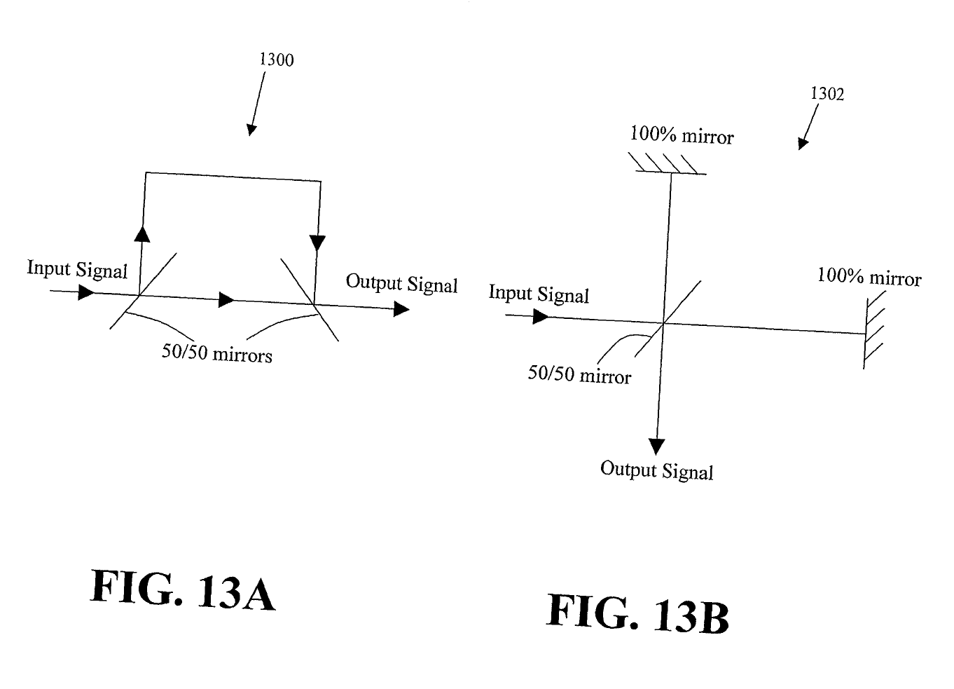

FIG. 13A and FIG. 13B illustrate other embodiments of interferometers which can be used according to the invention. FIG. 13A illustrates the Mach-Zehnder interferometer 1300 and FIG. 13B illustrates the Michelson interferometer 1302. By properly arranging the interferometers 1300 and 1302, such as in the parallel configuration of FIG. 12, alternative embodiments of the invention can be realized.

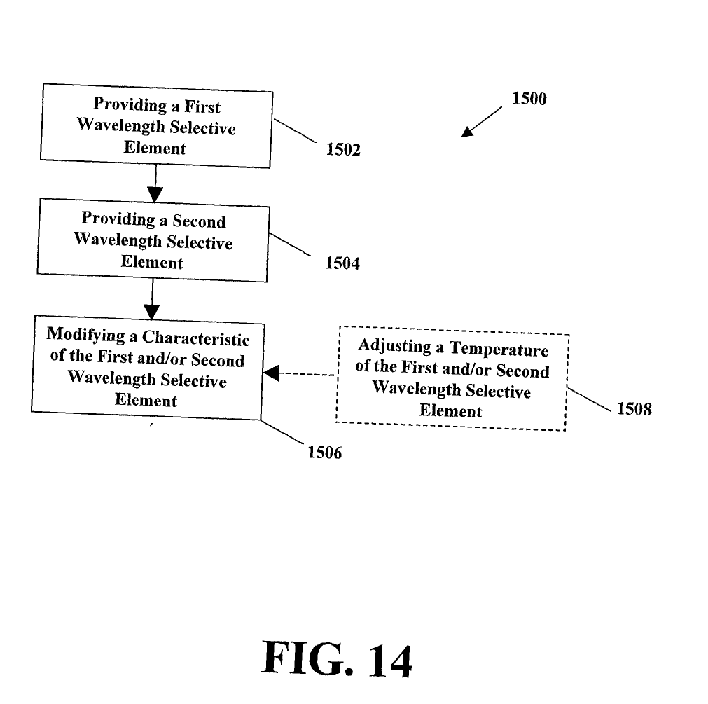

FIG. 14 illustrates a method of tuning a laser 1500 according to an embodiment of the invention. The method includes the step of providing a first wavelength selective element 1502 having a first thickness, a first refractive index and a first spectral response having a transmission peak. The method further includes the step of providing a second wavelength selective element 1504 having a second thickness, a second refractive index and a second spectral response having a transmission peak. The method also includes modifying 1506 at least one of the first thickness, the second thickness, the first refractive index and the second refractive index to generate an overlap of the transmission peak of the first spectral response and the transmission peak of the second spectral response. In one embodiment, the step of modifying includes adjusting a temperature 1508 of the first wavelength selective element. In one embodiment, by adjusting the temperature 1508 of the first wavelength selective element, the first thickness is modified.

Having described and shown the preferred embodiments of the invention, it will now become apparent to one of skill in the art that other embodiments incorporating the concepts may be used and that many variations are possible which will still be within the scope and spirit of the claimed invention. These embodiments should not be limited to disclosed embodiments but rather should be limited only by the spirit and scope of the following claims.

What is claimed as new and secured by Letters Patent is:

1. A wavelength tunable filter, comprising:
a first wavelength selective element having a first thickness, a first refractive index and a first spectral response having a plurality of transmission peaks, said plurality of transmission peaks having a first period;
a second wavelength selective element in optical communication with said first wavelength selective element, said second wavelength selective element having a second thickness, a second refractive index and a second spectral response having a plurality of transmission peaks, said plurality of transmission peaks having a second period; and
a control module in communication with at least one of said first and second wavelength selective elements, said control module adapted to vary at least one of said thickness, said second thickness, said first refractive index and said second refractive index, such that one of said plurality of transmission peaks of said first spectral response substantially overlaps one of said plurality of transmission peaks of said second spectral response.

2. The filter of claim 1 wherein at least one of said first thickness and said first refractive index is temperature dependent.

3. The filter of claim 2 wherein said control module is adapted to vary a temperature of said first wavelength selective element.

4. The filter of claim 1 wherein at least one of said second thickness and said second refractive index is temperature dependent.

5. The filter of claim 4 wherein said control module is adapted to vary a temperature of said second wavelength selective element.

6. The filter of claim 1 wherein at least one of said first and second periods is temperature dependent.

7. The filter of claim 1 wherein one of said first and second wavelength selective elements is temperature insensitive.

8. The filter of claim 1 wherein at least one of said plurality of transmission peaks having said first period corresponds to a wavelength division multiplexer channel.

9. The filter of claim 3 wherein each of said plurality of transmission peaks having said first period corresponds to a wavelength division multiplexer channel at a corresponding temperature of said first wavelength selective element.

10. The filter of claim 1 wherein at least one of said first and second wavelength selective elements is disposed within a laser cavity.

11. The filter of claim 10 further comprising a variable phase adjuster in optical communication with one of said first and second wavelength selective elements.

12. The filter of claim 1 wherein at least one of said first and second wavelength selective elements comprises an etalon.

13. The filter of claim 12 wherein said etalon comprises a surface having an electrically conductive film, a temperature of said etalon being responsive to an electric current conducted through said electrically conductive film.

14. The filter of claim 1 wherein at least one of said first and second wavelength selective elements comprises an interferometer.

15. A wavelength tunable laser, comprising:
a first mirror and a second mirror defining a laser cavity;
a gain element disposed in said laser cavity; and
a wavelength tunable filter disposed in said laser cavity, said wavelength tunable filter comprising:
a first etalon having a first thickness, a first refractive index and a first spectral response having a plurality of transmission peaks, said plurality of transmission peaks having a first period;
a second etalon in optical communication with said first etalon, said second etalon having a second thickness, a second refractive index and a second spectral response having a plurality of transmission peaks, said plurality of transmission peaks having a second period; and
a control module in communication with at least one of said first and second etalons, said control module adapted to vary at least one of said thickness, said second thickness, said first refractive index and said second refractive index, such that one of said plurality of transmission peaks of said first spectral response substantially overlaps one of said plurality of transmission peaks of said second spectral response.

16. The laser of claim 15 wherein at least one of said first thickness and said first refractive index is temperature dependent.

17. The laser of claim 16 wherein said control module is adapted to vary a temperature of said first etalon.

18. The laser of claim 15 wherein at least one of said second thickness and said second refractive index is temperature dependent.

19. The laser of claim 18 wherein said control module is adapted to vary a temperature of said second etalon.

20. The laser of claim 15 wherein at least one of said first and second periods is temperature dependent.

21. The laser of claim 15 wherein one of said first and second etalons is temperature insensitive.

22. The laser of claim 15 wherein at least one of said plurality of transmission peaks having said first period corresponds to a wavelength division multiplexer channel.

23. The filter of claim 17 wherein each of said plurality of transmission peaks having said first period corresponds to a wavelength division multiplexer channel at a corresponding temperature of said first etalon.

24. The laser of claim 15 wherein one of said first and second mirrors is a laser output mirror.

25. The laser of claim 15 further comprising a variable phase adjuster disposed in said laser cavity.

26. The laser of claim 15 wherein at least one of said first and second etalons comprises a surface having an electrically conductive film, a temperature of said at least one of said first and second etalons being responsive to an electric current conducted through said electrically conductive film.

27. A wavelength tunable laser, comprising:
a laser cavity;
a gain element disposed in said laser cavity; and
a wavelength tunable filter disposed in said cavity, said wavelength tunable filter comprising:
a first interferometer having a first optical path difference and a first spectral response having a plurality of transmission peaks, said plurality of transmission peaks having a first period;
a second interferometer in optical communication with said first interferometer, said second interferometer having a second optical path difference and a second spectral response having a plurality of transmission peaks, said plurality of transmission peaks having a second period; and
a control module in communication with at least one of said first and second interferometers, said control module adapted to vary at least one of said first optical path difference and said second optical path difference, such that one of said plurality of transmission peaks of said first spectral response substantially overlaps one of said plurality of transmission peaks of said second spectral response.

28. The laser of claim 27 wherein said first optical path difference is temperature dependent.

29. The laser of claim 28 wherein said control module is adapted to vary a temperature of said first interferometer.

30. The laser of claim 27 wherein said second optical path difference is temperature dependent.

31. The laser of claim 30 wherein said control module is adapted to vary a temperature of said second interferometer.

32. The laser of claim 27 wherein at least one of said first and second periods is temperature dependent.

33. The laser of claim 27 wherein one of said first and second interferometers is temperature insensitive.

34. The laser of claim 27 wherein at least one of said plurality of transmission peaks having said first period corresponds to a wavelength division multiplexer channel.

35. The filter of claim 29 wherein each of said plurality of transmission peaks having said first period corresponds to a wavelength division multiplexer channel at a corresponding temperature of said first interferometer.

36. The laser of claim 27 further comprising a variable phase adjuster disposed in said laser cavity.

37. A method of tuning a laser wavelength comprising:
providing a first wavelength selective element having a first thickness, a first refractive index and a first spectral response having a plurality of transmission peaks, said plurality of transmission peaks having a first period;
providing a second wavelength selective element having a second thickness, a second refractive index and a second spectral response having a plurality of transmission peaks, said plurality of transmission peaks having a second period; and
modifying at least one of said first thickness, said second thickness, said first refractive index said second refractive index to generate an overlap of one of said plurality of transmission peaks of said first spectral response and one of said plurality of transmission peaks of said second spectral response.

38. The method of claim 37 wherein said step of modifying comprises adjusting a temperature of at least one of said first and second wavelength selective elements.

39. A wavelength tunable filter, comprising:
first selection means for selecting a first plurality of wavelengths for transmission;
second selection means for selecting a second plurality of wavelengths for transmission, said first selection means being in communication with said second selection means; and
means for shifting at least one of said first plurality of wavelengths and said second plurality of wavelengths,
wherein one of said first plurality of wavelengths is substantially equal to one of said second plurality of wavelengths.
